(19) United States
(12) Patent Application Publication
(10) Pub. No.: US 2021/0346734 A1
(43) Pub. Date: Nov. 11, 2021

(54) FILTERING FACEPIECE RESPIRATOR MASK WITH DETACHABLE FILTER CARTRIDGE

(71) Applicant: D6 Inc., Portland, OR (US)

(72) Inventors: Ryan Newson, Portland, OR (US); Benjamin S. McGregor, Portland, OR (US); Edward C. Dominion, Portland, OR (US); Martin L. Troudt, Portland, OR (US)

(21) Appl. No.: 17/344,875

(22) Filed: Jun. 10, 2021

Related U.S. Application Data
(63) Continuation of application No. 17/220,918, filed on Apr. 1, 2021, now abandoned.
(60) Provisional application No. 63/003,785, filed on Apr. 1, 2020.
(60) Provisional application No. 63/007,337, filed on Apr. 8, 2020.
(60) Provisional application No. 63/022,438, filed on May 9, 2020.

(51) Int. Cl. A62B 23/02

(52) U.S. Cl. CPC A62B 23/02; A62B 18/084

(57) ABSTRACT

A respirator mask facepiece thermoformed from a sheet of polymer material includes an opening that is covered by a filter membrane, which may be part of a detachable disposable filter cartridge. The polymer material of the facepiece may be transparent to enable a wearer's lips to be seen. The filter cartridge may include a filter membrane attached to a carrier frame, and may be attached to the facepiece via a set of threads formed on the carrier frame and the facepiece, which draw the cartridge and facepiece together to form a seal therebetween. A latch, catch, or other similar structure may be formed in the facepiece and/or carrier frame to inhibit the cartridge from being inadvertently detached from the facepiece.

### RELATED APPLICATION DATA

This application is a continuation of and claims priority under 35 U.S.C. § 120 to U.S. patent application Ser. No. 17/220,918, filed Apr. 1, 2021, which claims the benefit under 35 U.S.C. § 119(e) of U.S. Provisional Patent Application Nos. 63/003,785, filed Apr. 1, 2020, 63/007,337, filed Apr. 8, 2020, and 63/022,438, filed May 9, 2020, all of which are hereby incorporated by reference.

### TECHNICAL FIELD

The field of the present disclosure relates to facepiece respirator masks of the kind used for filtering particulates from ambient air for protecting a wearer's lungs and for reducing the risk of inhalation of pathogens, irritants, and pollution.

### BACKGROUND

A common type of personal protective equipment for industrial and/or medical uses is an air-purifying particulate filtering respirator mask, also known as a filtering facepiece respirator. One common type of respirator mask is a NIOSH-certified N95 respirator, which blocks at least 95 percent of particulates larger than 0.3 microns under particular test conditions. Some such masks are used for industrial purposes, and some may be used for medical purposes or to mitigate the spread of disease.

In the wake of the COVID-19 pandemic, commercially available N95 respirator masks are in short supply. This is in part due to limitations on the existing manufacturing capacity for the required filter material, and yet most existing designs use much more material than necessary to achieve good performance. The production capacity for conventional designs is in part limited by the design of the mask, comprising a formed cup or cone of filter material plus applied sealing material, elastic straps, and a metal bridge band, as well as by the kind of equipment used to manufacture the masks. The present inventors have recognized that existing respirator mask designs have numerous other deficiencies, including that they are disposable, but not recyclable, and are opaque, which impedes communication with deaf persons who are otherwise able to read lips.

### BRIEF DESCRIPTION OF THE DRAWINGS

FIG. 1 is an oblique pictorial view of a facepiece respirator according to an embodiment;

FIG. 2 is a top pictorial view of the facepiece respirator of FIG. 1;

FIG. 3 is a front view of a facepiece respirator, with a securing headband omitted;

FIG. 4 is a bottom view of the facepiece respirator of FIG. 3;

FIG. 5 is an exploded isometric view of the facepiece respirator of FIG. 3;

FIG. 6 is a collection of isometric and plan views of a media holder bottom carrier ring (20) shown in FIG. 5;

FIG. 7 is a collection of isometric and plan views of a media holder top carrier ring (22) shown in FIG. 5;

FIG. 8 is a cross section view of the facepiece respirator of FIG. 3 taken along line 8-8 in FIG. 3;

FIG. 9 is an enlarged detail cross sectional view of a coupling region 9-9 in FIG. 8 of the facepiece respirator of FIG. 3; and

FIG. 10 is a collection of isometric and plan views of a facepiece component of the facepiece respirator of FIG. 3;

FIGS. 11 and 12 are respective front and bottom views of a facepiece respirator according to another embodiment;

FIG. 13 is an exploded isometric view of the facepiece respirator of FIGS. 11 and 12;

FIG. 14 is a bottom view of a facepiece respirator according to another embodiment, with a multi-layer filter shown in an inhalation condition;

FIG. 15 is a bottom view of the facepiece respirator of FIG. 14 with the multi-layer filter shown expanded/inflated under an exhalation condition;

FIG. 16 is a front view of the multi-layer filter of FIG. 14;

FIG. 17 is cross-sectional view of the multi-layer filter of FIG. 16 shown in an expanded/inflated condition;

FIGS. 18 and 19 are respective front and rear isometric views of a facepiece respirator according to yet another embodiment;

FIGS. 20, 21, 22, and 23 are respective front elevation, top, bottom, and left side views of the facepiece respirator of FIG. 18;

FIGS. 24 and 25 are respective front and rear isometric exploded views of the facepiece respirator of FIG. 18;

FIGS. 26, 27, 28, 29, and 30 are respective front isometric, front elevation, top, bottom, and left side views of a facepiece component of the facepiece respirator of FIG. 18, with an optional sealing gasket omitted; and

FIG. 31 is a cross section view of the facepiece respirator of FIG. 18 taken along line 31-31 of FIG. 20, showing detail of a twist-lock screw connection between the filter cartridge and facepiece of the facepiece respirator.

### DETAILED DESCRIPTION OF PREFERRED EMBODIMENTS

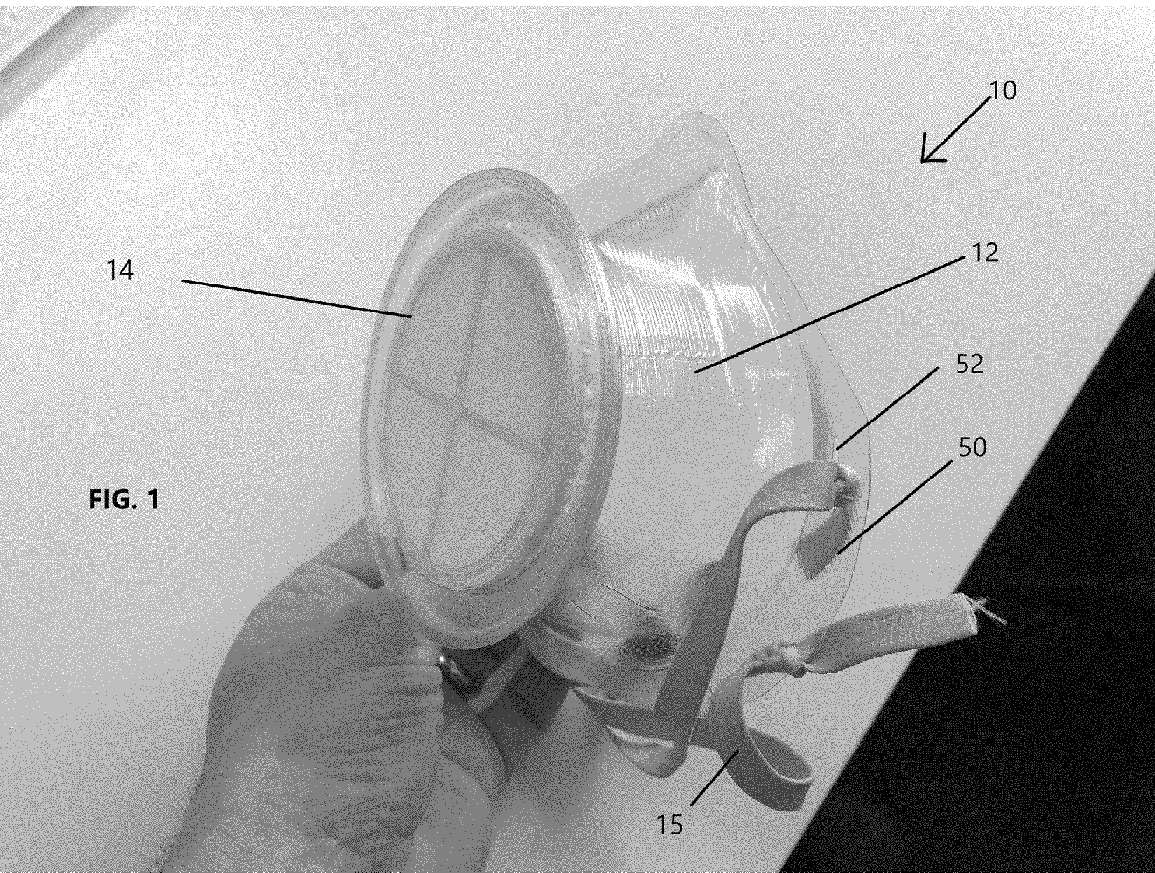

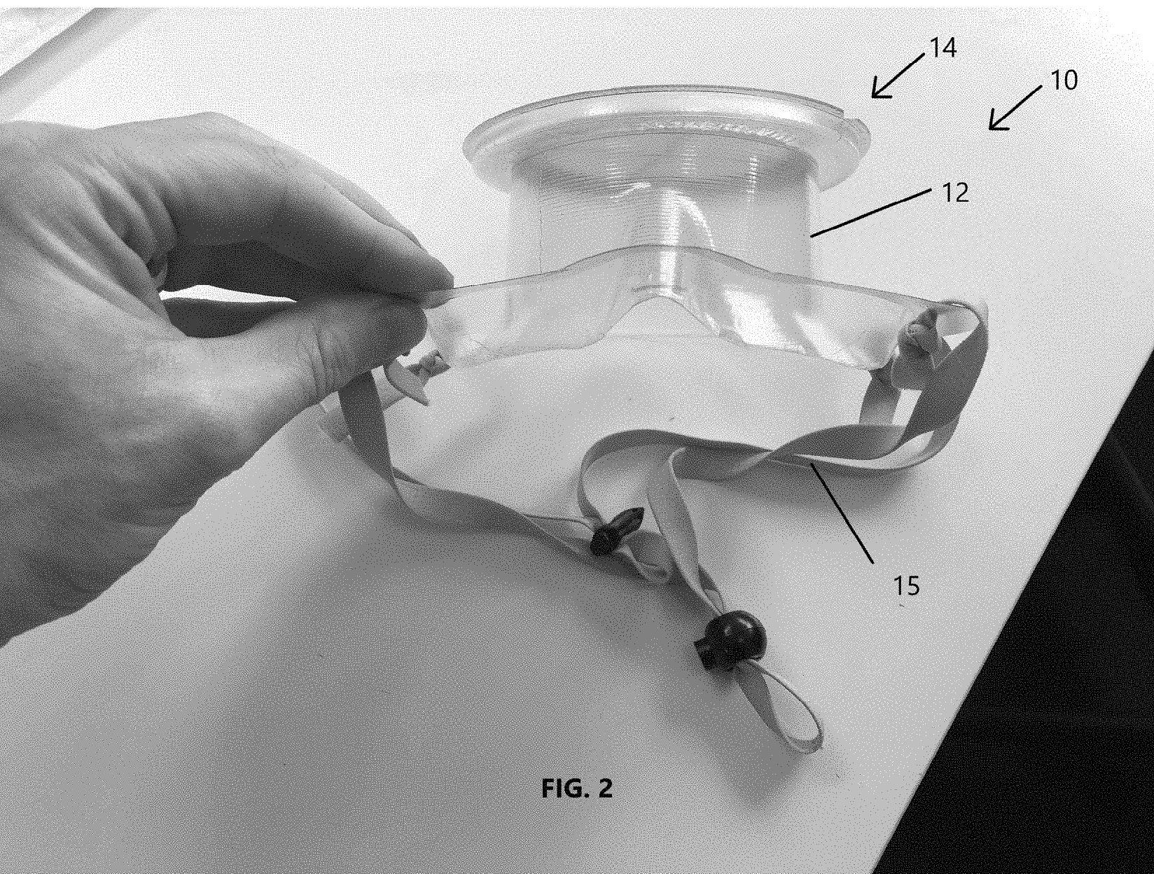

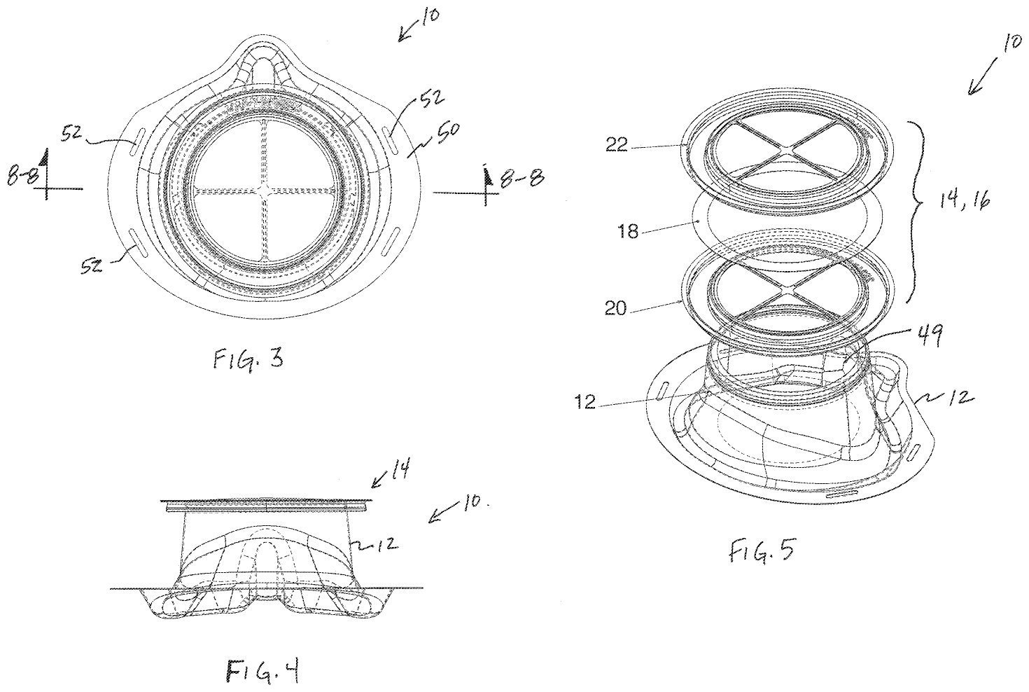

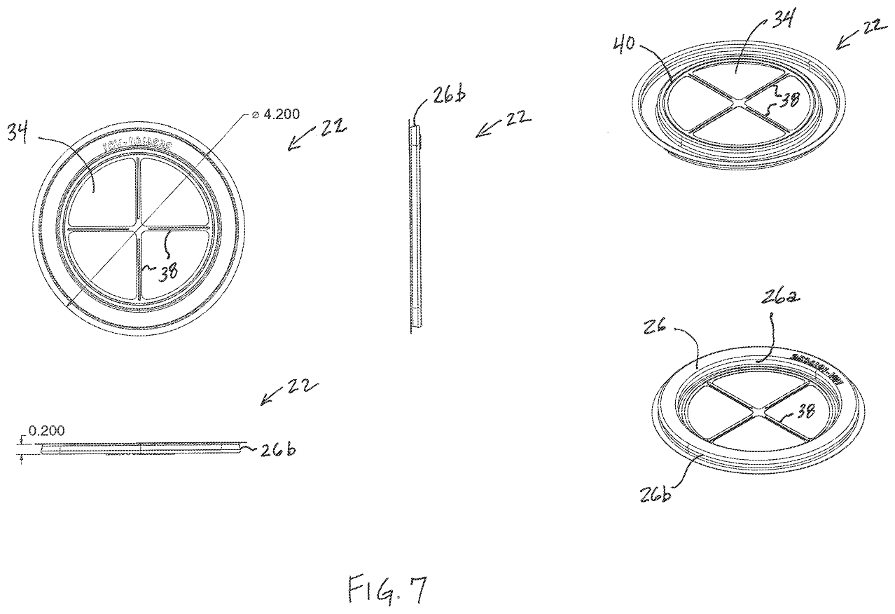

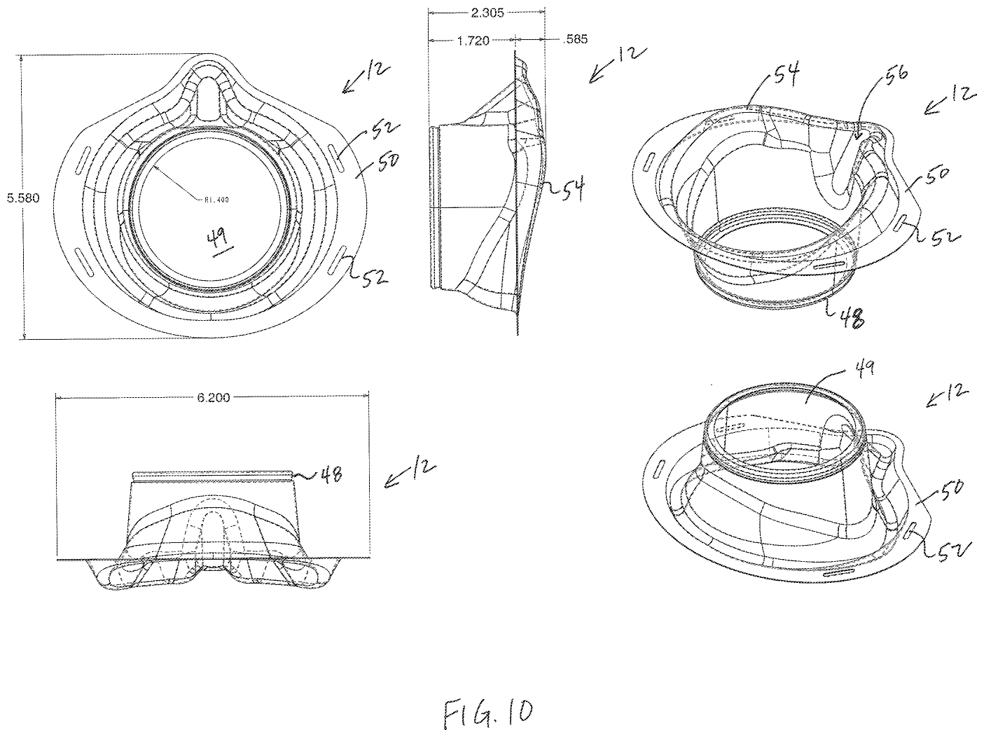

FIGS. 1-10 illustrate a recyclable facepiece respirator mask 10 according to a first embodiment, including a facepiece 12, and a filter 14. In one embodiment, the facepiece 12 is made of a recyclable thermoformable polymer material, such as transparent polypropylene (PP), polyethylene terephthalate (PET), high density polyethylene (HDPE), or poly-lactic acid (PLA), for example, enabling it to be mass produced from polymer film using automated thermoforming equipment. Suitable thermoforming equipment may be similar or identical to the kind of equipment used for manufacturing containers or packaging for food or other goods. Certain components of the filter 14 may also be recyclable and made using such polymer materials and equipment, as described below. Recyclable components of mask 10 may be disassembled by a consumer to facilitate recycling, cleaning, sterilization, and/or reuse, as further described below. One or more elastic bands 15 may be attached to facepiece 12 and worn around a user's head to hold the facepiece 12 securely to a wearer's face, around the wearer's nose and mouth. By virtue of facepiece 12 being made of a clear, transparent, or translucent polymer material, the wearer's lips may be visible through the side of mask 10 to allow lip-reading by another person who is hearing impaired or deaf. This aspect of the mask 10 may provide a significant advantage for health care and emergency response personnel, as it allows them to communicate with a hearing-impaired person or patient without removing their protective respirator mask and exposing them to potentially hazardous air. The use of thermoformable polymer material may also reduce chafing of a wearer's face and/or allow the fit of the facepiece to be customized by the user, as further explained below

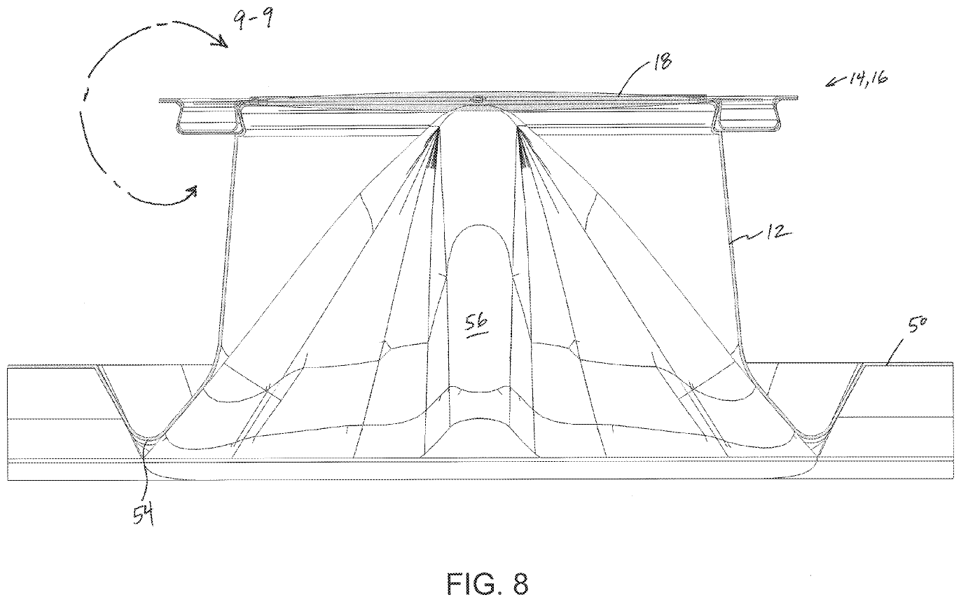

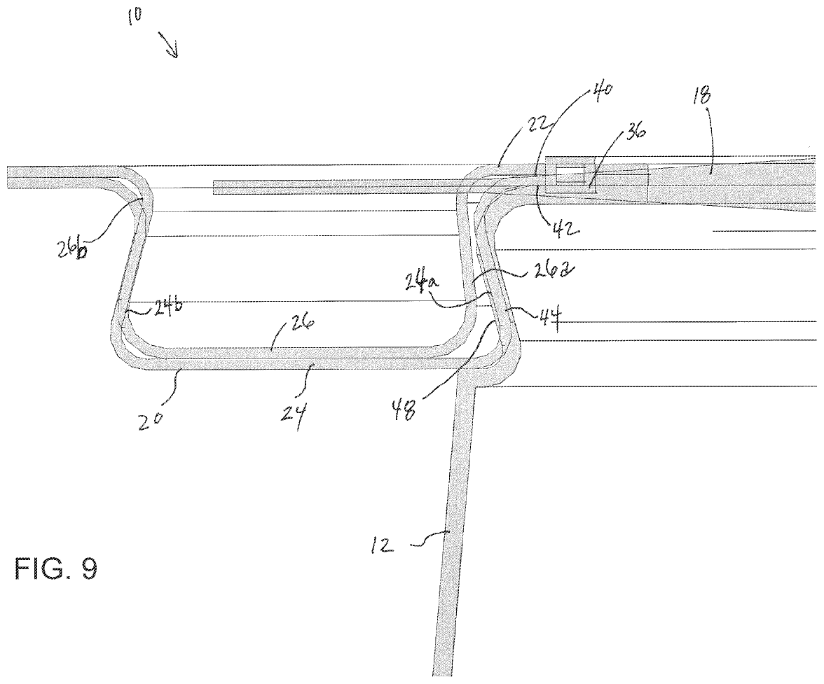

In one embodiment, the filter 14 may comprise a filter cartridge 16 including a filter membrane 18 carried by one or more carrier rings 20, 22. In the embodiment illustrated, the filter cartridge 16 is detachably attached to facepiece 12 and replaceable. In the embodiment illustrated in FIGS. 1-9, two carrier rings or media holders (including an inner (bottom) carrier ring 20, and an outer (top) carrier ring 22) are utilized, and the filter membrane 18 is sandwiched between the carrier rings 20, 22. In other embodiments, more than two carrier rings may be used. Filter membrane 18 may comprise one, two or more layers of particulate filtering material, such as a melt-blown non-woven polypropylene fabric. The carrier rings 20, 22 may be thermoformed from a recyclable polymer film material, such as PP or PET, and snap-fit together via a pair of interengaging undercut peripheral surfaces 24, 26 in much the same manner as the lid of a plastic food container is snapped onto the body of such a container, as best illustrated in FIGS. 8 and 9. The peripheral surfaces 24, 26 may be circular or another shape, such as square or rectangular, and are preferably annular—extending continuously along a closed path to ensure a good seal therebetween. The peripheral surfaces 24, 26 extend around openings 32, 34 in the respective carrier rings 20, 22, across which the filter membrane 18 is positioned to allow filtered air to flow therethrough. A raised sealing rib 36 may be attached to or formed on outer carrier ring 22 so as to encircle the openings 32, 34. One or more support struts 38 may span each of the openings 32, 34, and may include two perpendicular struts arranged in the form of cross or X, but more than two struts 38 may also be utilized on one or both of carrier rings 20, 22. The sealing rib 36 is preferably located in opposing relation to a sealing surface 40 of the inner carrier ring 20 so that, when the filter cartridge 16 is assembled, the sealing rib 36 compresses the filter membrane 18 and presses it against the sealing surface 40 to ensure a good seal, while also preventing filter membrane 18 from pulling loose from the carrier rings 20, 22. The peripheral surfaces 24, 26 are preferably undercut, shaped and sized with significant height (in a direction perpendicular to the openings 32, 34) to ensure substantial compressive forces along the sealing rib 36 and sealing surface 40. In the embodiment illustrated, the peripheral surfaces 24, 26 include U-Shaped cross sections having inner and outer undercut side surfaces 24a, 24b, 26a, 26b that deform to nest and tightly engage. The carrier rings 20, 22 are preferably of similar outer diameters, to improve a secure connection therebetween and inhibit inadvertent disassembly. The filter membrane 18 may have an outer diameter slightly smaller than carrier rings 20, 22 so that an outer margin of the filter membrane is captured between the U-shaped portions of peripheral surfaces 24, 26. (NOTE: Due to CAD artifacts, the outer margin of filter membrane 18 is shown in FIGS. 8 and 9 as being substantially planar, instead of properly following the contours of the U-shaped portions of peripheral surfaces 24, 26 and being sandwiched therebetween.)

In some embodiments a sealant or adhesive material (not shown) may be applied to one or more of the sealing rib 36 and/or sealing surface 40, or to one or more of peripheral surfaces 24, 26 to ensure an effective seal with the filter membrane 18 along the interface region between the carrier rings 20, 22. In an alternative embodiment (not illustrated), the filter membrane 18 may be glued, adhered, or otherwise bonded (e.g., by welding via thermal, ultrasonic, or RF welding techniques) to sealing surface 40 or peripheral surface 26 of inner carrier ring 20, or to an inner sealing surface 42 of inner carrier ring 20 facing toward a sealing surface of facepiece 12, and outer carrier ring 22 may be omitted. In still other embodiments (not illustrated), two sealing ribs may be utilized—one on outer carrier ring 22, and the other facing in opposing relation on inner carrier ring 22 or facepiece 12.

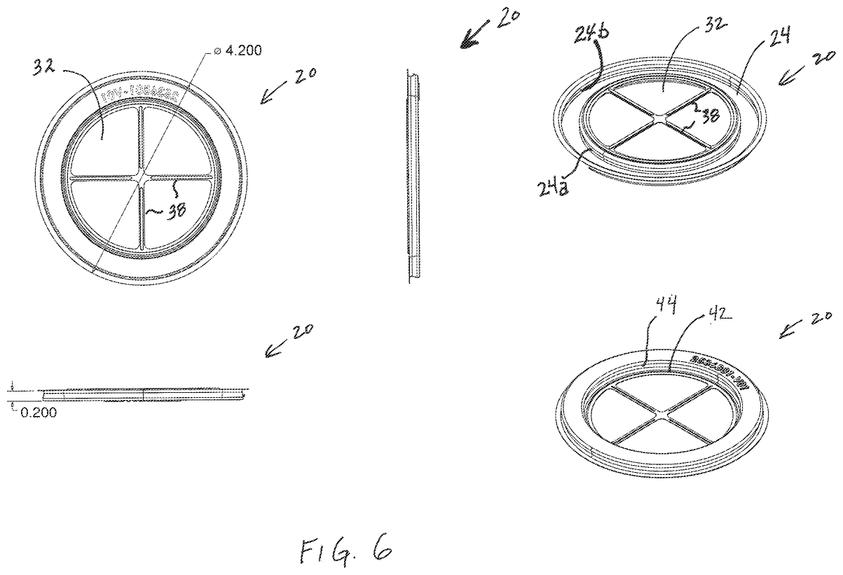

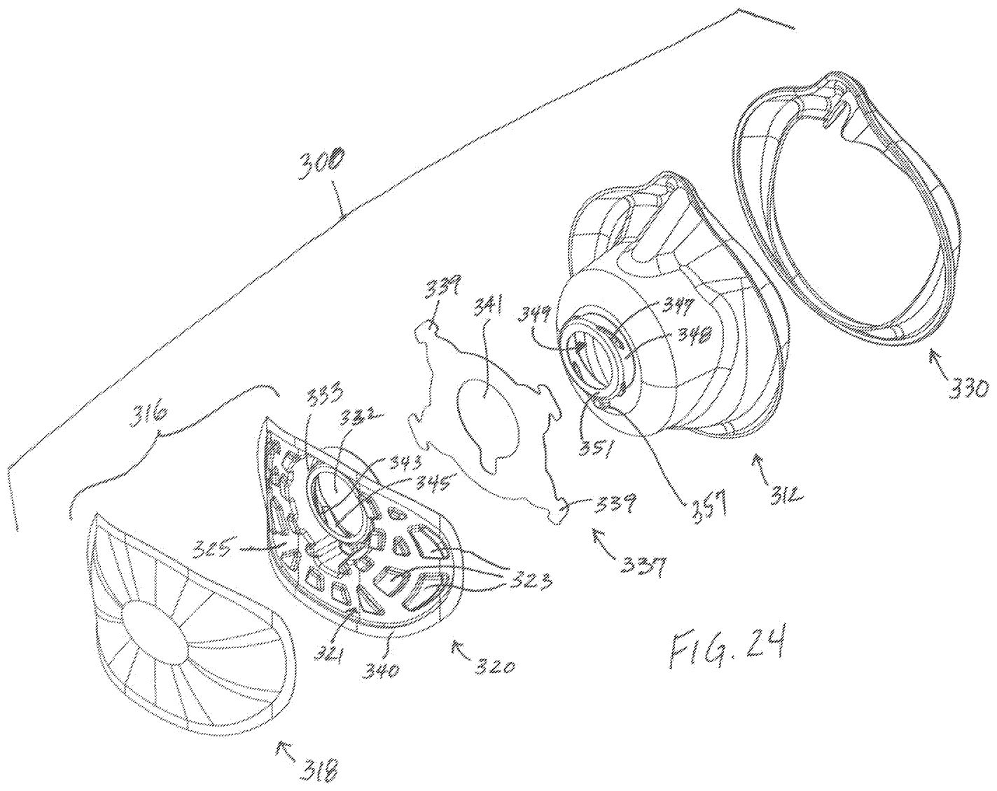

As noted above, the carrier rings 20, 22 may be attached together via a snap-fit connection via complementary peripheral surfaces 24, 26. As illustrated in FIGS. 6, 7, and 9, peripheral surface 24 in this embodiment comprises outer undercut surfaces 24a, 24b of inner carrier ring 20, and peripheral surface 26 comprises inner undercut surfaces 26a, 26b of outer carrier ring 22, which are complementary to and engage with outer undercut surfaces 24a, 24b of inner carrier ring 20. Inner carrier ring 20 also includes an inner undercut surface 44 opposite the outer peripheral undercut surface 24a. Inner undercut surface 44 of carrier ring 20 is snap-connected to facepiece 12 via an outwardly-facing coupling surface 48 surrounding an opening 49 of facepiece 12. Coupling surface 48 may be undercut, shaped complementary to inner undercut surface 44 of carrier ring 20 and sized to ensure a positive seal between ring 20 and facepiece 12. Many other methods and structures may also be utilized to detachably connect carrier ring 20 to facepiece 12. For example, a twist lock connection may be utilized, as is illustrated in FIGS. 24, 25, and 31, described below, or a bayonet mount may be utilized.

The detachable snap coupling or other detachable connection of filter cartridge 16 to facepiece 12 may facilitate replacement of filter cartridge 16, cleaning of facepiece 12 and other components of mask 10, and sterilization and reuse of used filter cartridges 16. Such a detachable coupling may also allow facilitate recycling of facepiece 12, while facilitating proper disposal of used filter cartridges as hazardous medical waste. The ability to reuse facepiece 12 may also reduce waste to landfills. The relatively small size and thin profile of filter cartridges 16 facilitates shipping and reduces packaging (environmental benefit), and more efficiently uses available space in sterilizing units (better throughput and reduced energy usage). Reusable facepieces 12 may be made available in a variety of sizes and shapes to fit different sizes and shapes of faces of various users.

Facepiece 12 may be shaped to include a flange portion 50 bordering face-engaging opening. Slots 52 (FIG. 1) may be formed in flange portion 50 for attachment of elastic headbands 15 or other lashings for attaching mask 10 to a wearer's head as illustrated in FIG. 1. Flange portion 50 may be a return flange that extends outwardly from a raised ridge 54 that provides a reduced-area contact ring for sealing against a wearer's face. In other embodiments, the return flange portion 50 may be omitted, as illustrated in FIGS. 11-15, and slots 252 for attachment of headbands or other lashings may be formed in a media carrier ring 220. Ridge 54 may be irregularly contoured to approximately fit an average face shape. Omitting the return flange 50 may increase flexibility of facepiece 12 along ridge 54 to improve fit. In some embodiments, a resilient gasket material (not illustrated), such as a closed-cell foam, may be applied to ridge 54 to improve sealing against the wearer's face or to reduce slippage, or for other reasons. In some embodiments, the slots 52 may allow bands to be adjustable to fit different sized heads and to optimize tension to ensure a good fit and seal between flange portion 50 and a wearer's face. The facepiece 12 may also include a formed internal recess 56 or bridge for accommodating the wearer's nose.

In some embodiments, the fit of facepiece 12 may be further customized by a user using a thermoforming method, in which the polymer material of facepiece 12 is heated—for example in a microwave oven or hot water—to soften the material sufficiently such that it conforms to the wearer's face when donned immediately after heating; thereafter cooling to retain a customized shape. Thus, the present disclosure also encompasses a method of customized fitting of a facepiece respirator including providing a facepiece 12 formed of a thermoformable material, heating the facepiece 12 until the thermoformable material is softened, donning the facepiece while softened, and optionally tightening elastic bands 15 or other attachment bands. The filter cartridge 16 may be removed during fit customization and thereafter replaced.

The entire facepiece respirator mask 10 may be delivered assembled as a kit, or may be delivered disassembled (in parts) and assembled by the user. Facepiece 12 and carrier rings 20, 22 may be thermoformed from a post-consumer polymer film material, or a blend of virgin resin and post-consumer recycled polymer material, to thereby reduce environmental impacts. The use of a thermoformed polypropylene or PET film material with a smooth surface is expected to be more comfortable on a wearer's face than a conventional cloth respirator mask which may tend to chafe and to absorb oils from the wearer's skin.

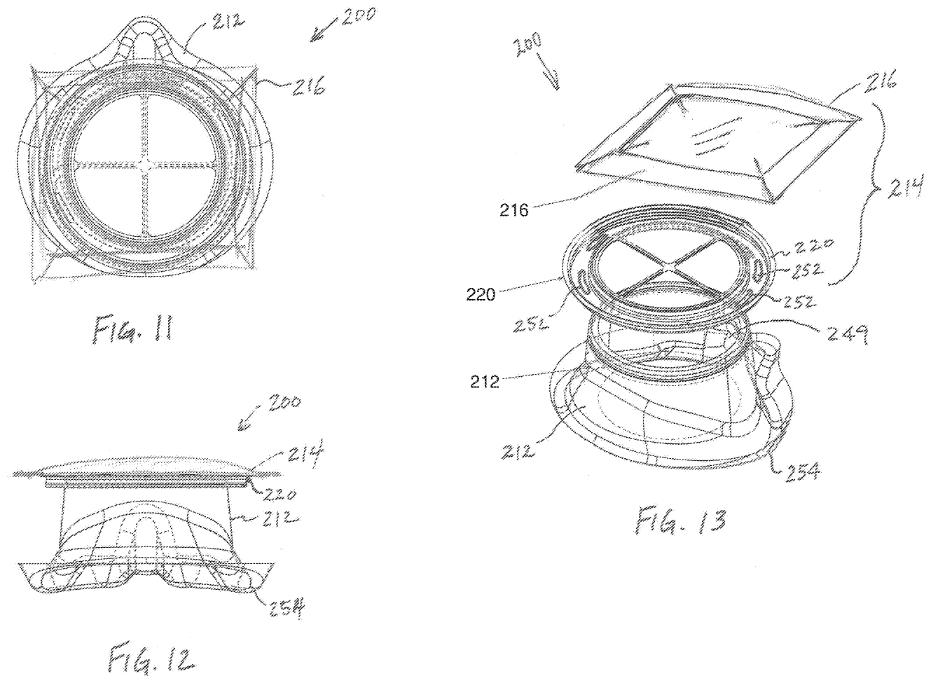

FIGS. 11-13 illustrate a respirator mask 200 according to another embodiment, in which a facepiece 212 is similar to facepiece 12, but lacking flange 50, and utilizing a different type of filter 214. With reference to FIGS. 11-13, filter 214 includes a non-woven filter fabric or membrane that is bonded directly to a carrier ring 220. Slots 262 may be formed in carrier ring 220 for attachment of elastic bands or other lashings (not illustrated), which will also help to retain a snap-fit connection between carrier ring 220 and facepiece 212 when in use. As further described below with reference to FIGS. 14-17, filter 214 may include a multi-layer assembly that may expand during exhalation, which may increase filtering surface area while reducing flow resistance. Filter 214 may be square or polygonal as illustrated in FIGS. 11 and 13, or may be circular as illustrated in FIG. 16.

FIGS. 14 and 15 illustrate the respirator mask 200 of FIGS. 11-13 with a circular filter medium assembly 216 of filter 214 bonded to carrier ring 220, for example via a heat welding technique. FIG. 14 shows the filter medium assembly 216 deflated during an inhalation condition, and FIG. 15 shows filter medium assembly 216 inflated during exhalation to form an expanded pocket-like or bag-like structure.

FIG. 16 shows a front elevation view of filter medium assembly 216 (with carrier ring 220 omitted). Filter medium 216 includes two or more layers 262, 268 of non-woven filter fabric or filter membrane bonded together along one or more bonding regions 242, 244. An inner layer 262 of filter medium 216 may include an opening 266 corresponding to an opening 249 in carrier ring 220 and facepiece 212, which may facilitate flow (during inhalation and exhalation) while allowing inflation or pillowing of an outer layer 268 of filter medium 216 during exhalation, as illustrated in FIGS. 15 and 17. In other embodiments, opening 266 may be omitted, so that the inner layer 262 spans opening 249 in facepiece 212. During assembly of filter 214, inner layer 262 may be bonded to carrier ring 220 before outer layer 268 is bonded to inner layer 262 along bonding regions 242, 244, allowing outer layer 268 to expand during exhalation as illustrated in FIGS. 16 and 17. FIG. 17 illustrates an optional internal third layer 280 of filter 214 which may comprise a non-woven melt-blown filtering material, or may comprise a more porous structural material having greater tensile strength and lower elongation, such as a woven polypropylene or polyester material, for example. Third layer 280 may be bonded to inner and outer layers 262, 268 along bonding regions 242, 244. In other embodiments, more than three layers may be utilized to achieve desired filtering performance and flow performance, or third layer 280 may be omitted.

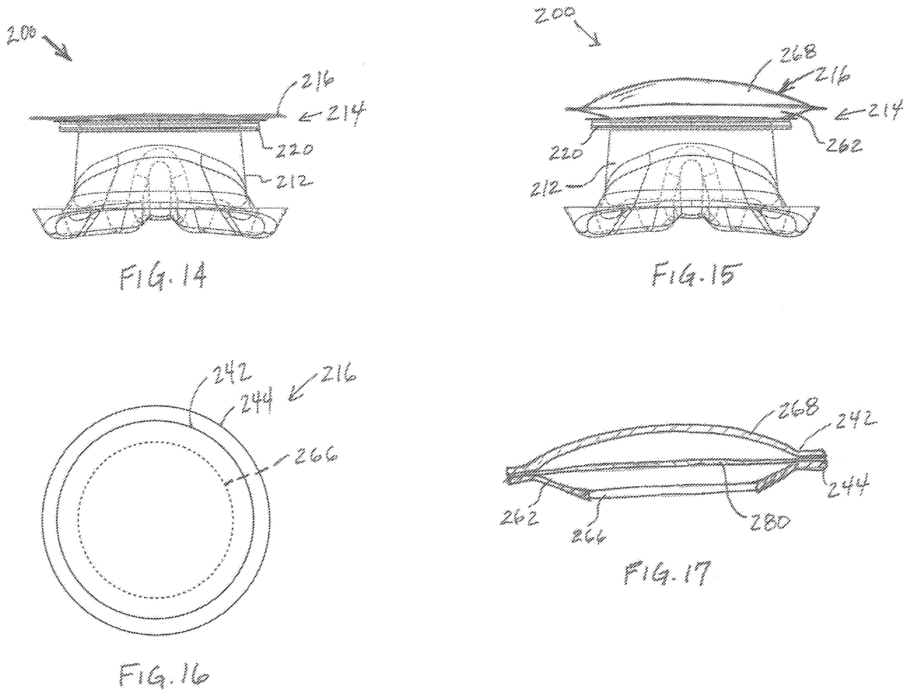

FIGS. 18-31 illustrate details of a filtering facepiece respirator mask 300 in accordance with yet another embodiment. In FIGS. 18-31, reference numerals in the 3xx series typically (but not always) will identify parts and elements of respirator mask 300 that correspond to parts and elements of respirator mask 10 of FIGS. 1-10 and respirator mask 200 of FIGS. 11-17 having the same last two digits and same or similar names. For example, respirator mask 300 includes a facepiece 312 corresponding to facepieces 12 and 212 of respirator masks 10 and 200, respectively.

Turning to FIGS. 18 and 19, respirator mask 300 includes a filter cartridge 316 detachably mounted to facepiece 312. Filter cartridge 316 carries a filter membrane 318 and has a convex forward-facing surface 306. Filter cartridge 316 is illustrated as having an oval shape, but other shapes are possible, such as rectangular, circular, and polygonal. The oval shape of filter cartridge 316 having its major dimension extending horizontally may allow filter membrane 318 to have a larger surface area without occluding a field of view of the wearer. The curved perimeter shape of filter cartridge 316 and swept-back convex profile may help to prevent edges 308 of the filter cartridge 316 from catching on other objects and pulling the mask away from the user's face. The swept-back shape may also divert air over the surface of filter cartridge 316 and reduce the amount of forced air entry through membrane 318, for example due to wind or relative airflow around the respirator mask 300 as a user walks or runs. In other embodiments, filter cartridge may have a flat profile or other profile.

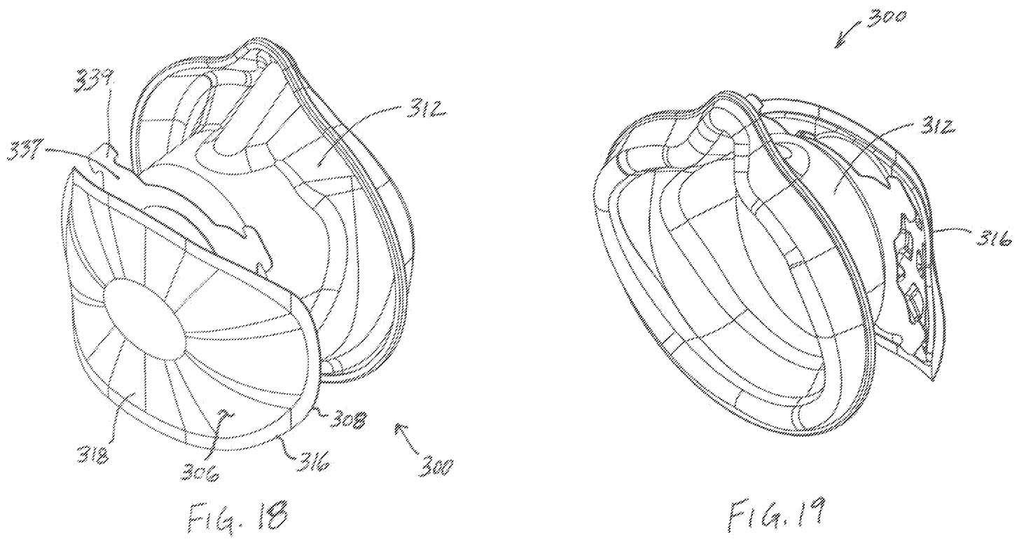

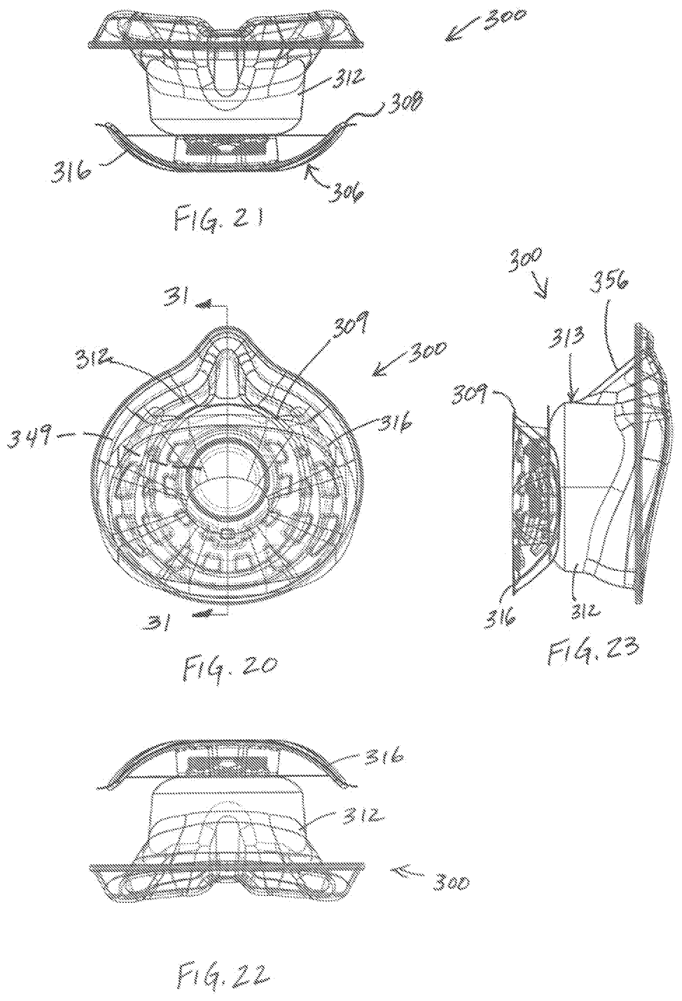

FIGS. 20-23 illustrate that filter cartridge 316 may be mounted off-center relative to an opening 349 in facepiece 312, so that an upper edge 309 of filter cartridge 316 sits lower relative to facepiece 312 to reduce obstruction of a wearer's field of view. As illustrated in FIG. 23, upper edge 309 of cartridge 316 may sit lower than the top surface of a snout portion 313 of facepiece 312 that extends forward of a nose bridge 356 of facepiece 312.

FIG. 24 illustrates an exploded isometric view of respirator mask 300. With reference to FIG. 24, filter cartridge 316 is comprised of a carrier 320, which may provide a coupling adapter for attachment to facepiece 312 and a frame for mounting filter membrane 318. Filter membrane may comprise one, two, three, or more layers of particulate filtering material, such as a melt-blown non-woven polypropylene fabric. Carrier 320 may be thermoformed from a sheet of polymer material, such as polypropylene (PP), polyethylene terephthalate (PET), high density polyethylene (HDPE), or poly-lactic acid (PLA), for example. Filter membrane 318 may be thermally bonded or fused to a marginal surface 340 of carrier 320, for example by a hot plate welding technique or an ultrasonic or RF welding technique, leaving a central region of membrane free to float relative to carrier 320. To facilitate bonding and improve adhesion of the nonwoven fabric filter membrane 318 to carrier 320, one or both of the facing portions of marginal surface 340 and filter membrane 318 may include a layer or coating of a weld-promoting material. In one embodiment, the weld-promoting material is a laminate or layer of ethylene-vinyl alcohol copolymer (EVOH), which may be co-extruded with or otherwise deposited onto and fused with PP or PET film. Facepiece 312 and carrier 320 may be formed of the same or different virgin or recycled resins. For example, facepiece 312 may be thermoformed from transparent PP, PET, HDPE or PLA having a thickness in the range of between 8 mils and 100 mils, for example in the range of between about 12 mils and 25 mils, or in the range of about 15 mils to 22 mils. The thickness of the film may impact the ability of facepiece 312 to properly conform to and seal against a wearer's face. Optionally, a gasket 330 formed of silicone or other soft pliable material may be fitted to facepiece 312 to improve sealing and comfort.

The manufacture and assembly of respirator mask 300 may be automated through the use of equipment common to automated thermoforming operations, such as robotic pick-and-place equipment, hot-plate-welding equipment, web handling and alignment, die cutting, and other parts handling and assembly equipment.

When respirator mask 300 is in use, during inhalation the filter membrane 318 is drawn inwardly toward an outer face 321 of carrier 320. Outer face 321 includes a plurality of standoffs 323 in the form of islands or ridges, which project forwardly of outer face 321 to prevent membrane 318 from fully sealing against outer face 321 during inhalation and effectively reducing the filtering area. The ribs or islands comprising the standoffs 323 may be arranged to provide flow pathways 325 that radiate from a central opening 332 in carrier 320. A recess 333 may be provided immediately around opening 332 to further increase the region of 318 that cannot be drawn against carrier 320. The dimensions and arrangement of the standoffs 323 and recess 333 may be selected and sized to reduce dead space, which may otherwise trap carbon dioxide and moisture within the respirator mask 300, and to limit obstruction and thereby reduce flow resistance to provide adequate flow during inhalation. During exhalation, filter membrane 318 may be slightly pillowed or flexed away from outer face 321 of carrier 320, thereby increasing filtering surface area and reducing flow resistance.

Filter cartridge 316 is detachably coupled to facepiece 312 via a screw connection that aligns opening 332 in carrier 320 with opening 349 of facepiece 312. Opening 332 of carrier 320 may be offset vertically on carrier 320 to lower the position of filter cartridge and improve the wearer's sight lines, as previously discussed. A securement plate 337, which may be die cut from recyclable polymer film, may include two, four, or more holes or notched tabs 339 to which elastic bands (not illustrated) may be tied or otherwise attached for securing the respirator mask 300 to a wearer's head. Securement plate 337 includes a central opening 341 so that it is retained against facepiece 312 by filter cartridge 316, when filter cartridge 316 attached to facepiece 312 via the screw connection.

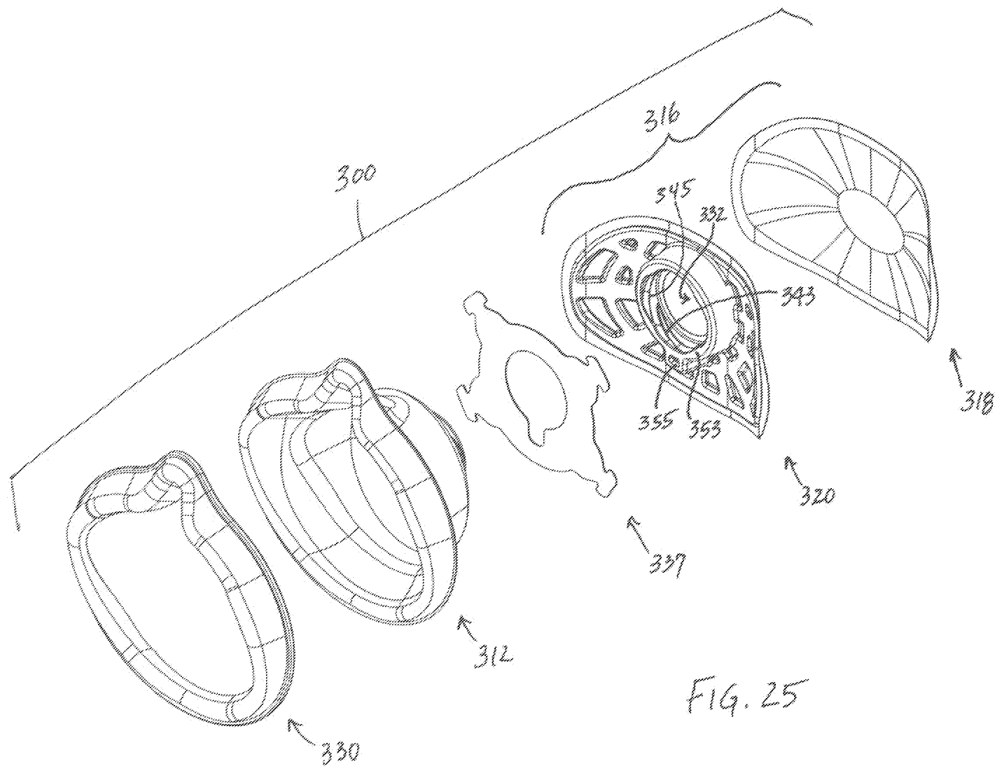

The screw connection includes a first set of threads 343 (best seen in FIG. 25) formed on an inner cylindrical surface 345 of carrier 320 bordering opening 332. The screw connection further includes a second set of threads 347 formed on an outer cylindrical surface 348 of facepiece 312 surrounding opening 349. A sealing flange 351 may project radially-inward from the forward end of outer cylindrical surface 348. Similarly, filter carrier 320 may include a flange 353 that faces facepiece 312 and surrounds opening 332. A locking receptacle 355 may be formed in flange 353 for receiving a locking button 357 of facepiece 312 (FIGS. 24 and 26-30), as further described below.

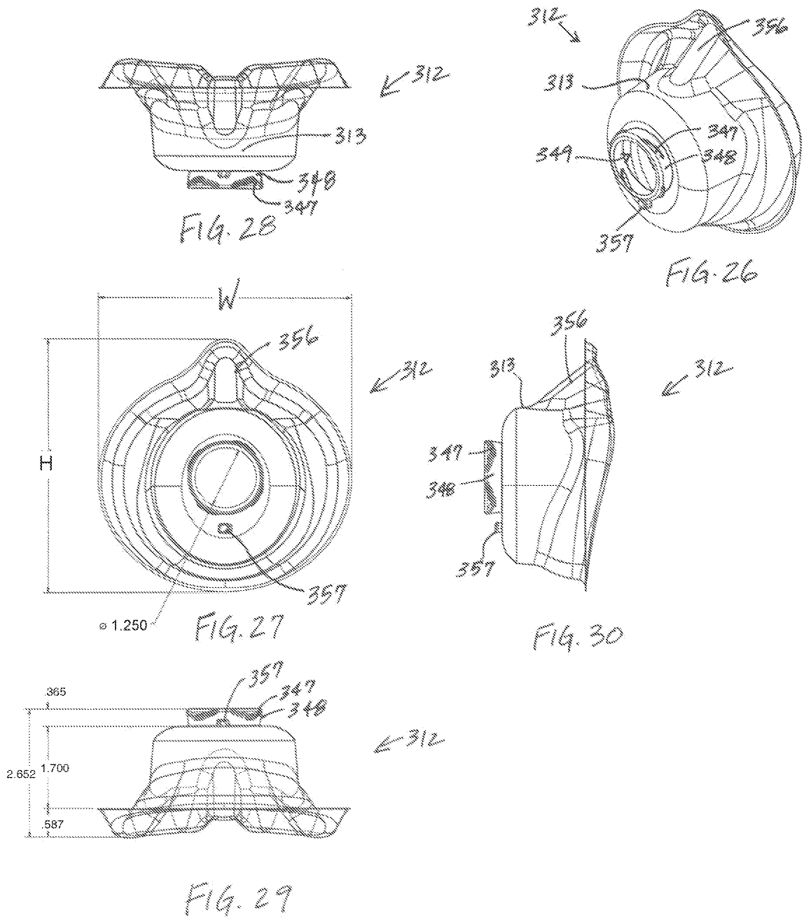

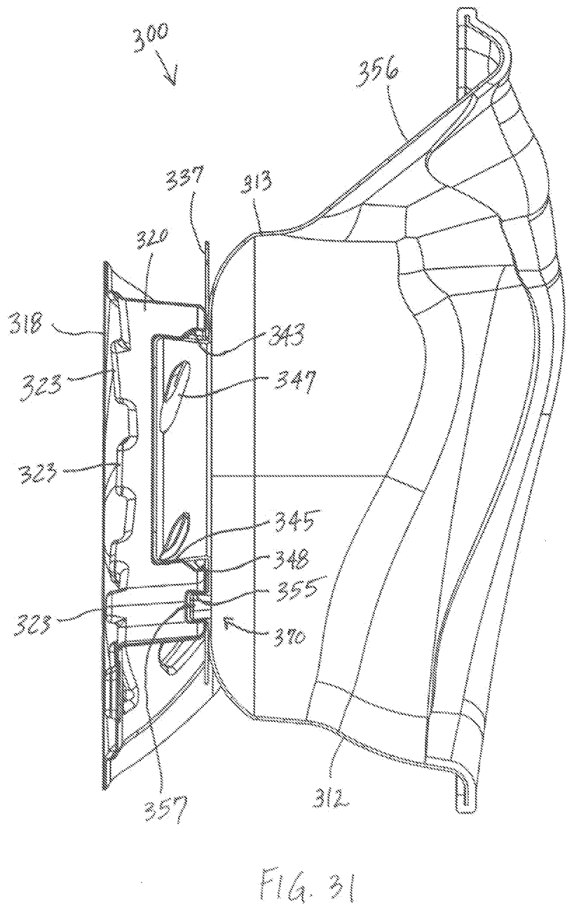

FIGS. 26-30 illustrate features of facepiece 312 heretofore described. With reference to FIG. 27, facepiece 312 may be manufactured in multiple sizes (such as small, medium, large, XL, etc) to fit different sized faces. Each size may have a different height (H) and width (W), and the face-engaging profile curvature of facepiece 312 (best illustrated in FIG. 30), may vary from one size to the next. The interior surface of facepiece 312 may include an anti-fog coating, such as a silicone coating, to reduce condensation of vapor on the interior surface. Facepiece 312 may also include an anti-static treatment or coating, such as a corona treatment, to facilitate stacking and unstacking of multiple facepieces 312 during manufacturing and shipment. Facepiece 312 is also washable using dish soap, a disinfectant wipe, or another cleaning substance, and may be easily disinfected between uses.

FIG. 31 is a cross section view of respirator mask 300 taken along line 31-31 of FIG. 20. With reference to FIG. 31, a latch mechanism 370 may comprise a latch, such as button 357, and a catch, such as locking receptacle 355. Button 357 and receptacle 355 may be tapered or undercut so as to snap-fit together when aligned after filter cartridge 316 is screwed into place on facepiece 312. In other embodiments, the latch and catch may both be raised toward each other, relative to the surfaces from which they are formed, so as to provide rotatably interfering stops that inhibit inadvertent unscrewing of filter cartridge 316 from facepiece 312. Thus, the latch mechanism provides a tamper-resistant function in combination with screw threads 347 and 343. As illustrated in FIG. 31, the inner and outer cylindrical surfaces 345 and 348 may be tapered to provide a retention fit and to improve sealing. The tapered cylindrical surfaces 345 and 348 illustrated in FIG. 31 are undercut (negative tapers), but may alternatively be positive tapers in other embodiments. Screw threads 347 and 343 may be sized and positioned to allow overcamming of the screw connection to provide a press fit at one or more interfaces between carrier 320 and facepiece 312, such as between flanges 351 and 353. A sealant or sealing gasket may optionally be provided at the interface between carrier 320 and facepiece 312.

It will be obvious to those having skill in the art that many changes may be made to the details of the above-described embodiments without departing from the underlying principles of the invention. The scope of the present invention should, therefore, be determined only by the claims.

1. A respirator mask comprising a facepiece formed by thermoforming from a sheet of polymer material, the facepiece having an opening therein, and a filter membrane covering the opening.

2. The respirator mask of claim 1, wherein the polymer material is transparent.

3. The respirator mask of claim 1, wherein the filter membrane is carried by a first carrier.

4. The respirator mask of claim 3, wherein the first carrier is snap-fit to the facepiece around the opening.

5. The respirator mask of claim 3, wherein the first carrier is detachably mounted to the facepiece via a screw connection.

6. The respirator mask of claim 5, wherein the first carrier is thermoformed from a sheet of polymer material.

7. The respirator mask of claim 6, wherein the screw connection includes a first set of threads thermoformed in the first carrier, and a second set of threads thermoformed in the facepiece around the opening and arranged to engage with the first set of threads when the first carrier is threaded onto the facepiece, to thereby draw the first carrier and the facepiece together to form a seal therebetween.

8. The respirator mask of claim 7, wherein the first set of threads is formed on an inner cylindrical surface of the first carrier, and the second set of threads is formed on an outer cylindrical surface of the facepiece.

9. The respirator mask of claim 8, wherein the inner and outer cylindrical surfaces are tapered.

10. The respirator mask of claim 6, wherein the filter membrane is thermally bonded to a marginal surface of the first carrier to form a filter cartridge.

11. The respirator mask of claim 5, wherein one of the facepiece and first carrier includes a latch and the other of the facepiece and the first carrier includes a catch, the latch and catch interfering when the first carrier is fully screwed onto the facepiece to inhibit the screw connection from coming unscrewed.

12. The respirator mask of claim 11, wherein the latch includes a locking button and the catch includes a locking receptacle, the locking button and locking receptacle being aligned and the locking button being received in the locking receptacle when the first carrier is fully screwed onto the facepiece.

13. The respirator mask of claim 11, wherein the latch and the catch are located radially-outward from the screw connection so that at least one of the latch and catch is axially displaceable relative to the other via manual flexure of a portion of the facepiece or a portion of the first carrier, or both, to thereby disengage the latch and the catch to allow the screw connection to be unscrewed.

14. The respirator mask of claim 3, wherein the first carrier is a first carrier ring, and further comprising a second carrier ring snap-fit to the first carrier ring independently of the faceplate with the filter membrane sandwiched between the first and second carrier rings to form a filter cartridge assembly.

15. The respirator mask of claim 14 wherein the filter cartridge is detachable from the facepiece.

16. The respirator mask of claim 1, further comprising a resilient gasket attached to the facepiece.
